(19) United States
(12) Patent Application Publication
(10) Pub. No.: US 2015/0284942 A1
(43) Pub. Date: Oct. 8, 2015

(54) BACK PRESSURE MANIFOLD SEPTIC SYSTEM AND METHOD

(71) Applicant: Gerald Philip BRUCE, Ontario (CA)

(72) Inventor: Gerald Philip BRUCE, Ontario (CA)

(21) Appl. No.: 14/246,217

(22) Filed: Apr. 7, 2014

(51) Int. Cl. E03F 3/00; B05B 1/00

(52) U.S. Cl. CPC E03F 3/00; B05B 1/00

(57) ABSTRACT

The invention provides a septic system with a source of waste water effluent, a pressurized downstream flow from the source, a distribution header to receive the downstream flow, an unpressurized drainage field with a plurality of lateral drainage lines adapted to receive the downstream flow from the header, and a flow restriction between the header and the laterals creating a positive back pressure in the header. The flow restriction includes a flow orifice located between the header and the lateral which forms a nozzle to produce an accelerated stream of effluent into the lateral.

### FIELD OF THE INVENTION

The field of the present invention is soil absorption systems as used with septic tanks for disposal of waste water and sewage into a drainage field.

### BACKGROUND

A septic system usually includes three components: the septic tank or other source of effluent waste water, a drainage field or tile bed and the soil beneath the drainage field. The tank must be a watertight container constructed of a solid, durable material resistant to corrosion or decay (concrete, fiber reinforced plastic, fibreglass, or polyethylene). The septic tank source is connected to a piping system forming the drainage field which distributes the wastewater effluent into subsurface soil for absorption and subsequent treatment.

Clarified septic tank effluent exits the septic tank and enters the soil absorption system (the “drainage field”) where a biological “clogging mat” or “biomat” forms. The mat contributes to even distribution of the waste water into the drainage field (U.S. EPA, 1980a; Hoover et. al., 1996.) Usually between two and four feet (or sometimes less) of unsaturated soil is required beneath the drainage field to renovate wastewater before it reaches a “limiting layer”—the point at which conditions for waste renovation becomes unsuitable. The soil absorption area must remain unsaturated for proper system functioning.

Absorption beds and trenches are the most common design options for soil absorption systems. These usually include a number of independent pipe distribution lines (referred to as laterals) with perforations to allow wastewater to enter the soil absorption area at various spread out locations.

Failure of septic systems to adequately treat wastewater can be environmentally hazardous. Failure may be related to inadequate sitting, inappropriate installation, or neglectful operation. Hydraulic overloading has been identified as a major cause of system failure (Jarrett et al., 1985).

Design of subsurface disposal beds and trenches varies greatly due to specific site conditions. Most often a series of perforated pipes or lateral lines are interconnected for gravity flow. Dosing or pressurized distribution systems may be installed to ensure a more complete distribution of the effluent to each trench (U.S. EPA, 1980a.) over its active area without significant overload.

Use of alternating valves permits switching between beds or trenches to allow drying out or resting of the system. A dosing system with a gravity fed pipe system is useful in areas of both high groundwater and permeable soils, where shallow gravel ditches (installed from 22.86 to 30.48 centimetres below grade) are employed. Another option is the use of drip irrigation.

For systems that are properly sited, sized, constructed, and maintained, septic tank/soil absorption has proven to be an efficient and cost effective method of on-site wastewater treatment and disposal. Many operating without mechanical equipment and when properly maintained soil absorption systems can have a service life in excess of 20 years. (Excerpts from Decentralized Systems Technology Fact Sheet, United States Environmental Protection Agency, Office of Water, Washington, D.C., EPA 932-F-99-075, September 1999).

In such systems typically neither up to the first few feet of each distribution line nor the manifold header is perforated so as to channel the wastewater flow available for that line to the defined drainage field. The drainage field dimensions and shape are site specific so to accommodate carriage of that flow as evenly as possible to the distribution perforations and from there into the absorption layer without hydraulic, saturation or other overload over the full life time of the field. Typically the perforations closest to the header accommodate the flow until they become saturated.

On the one hand, pressurized drainage fields require closed piping and relatively small size nozzles to maintain field pressure evenly over the entire system with a limited flow. Small nozzles are inconsistent with the clarity of the typical wastewater at this stage of processing and rapidly become clogged. Complex mechanical and chemical systems seek to overcome this clogging and the biological load so as to prevent saturation.

On the other hand, gravity fed systems can carry a larger loading of undigested debris across fields of variable permeability (by design or by the development of a biomat) and of different shapes by reason of the larger perforations but are not uniform in actual use. These remain prone to saturation and premature failure.

### PRIOR ART

A typical drainage field (as shown in FIGS. 1 and 2) is formed by a series of parallel perforated lines interconnected at the upper end by a non-perforated header or manifold. Dosing flow enters the manifold at any convenient point, preferably towards the center of the field, and is diverted by the manifold and continues flow by gravity.

Investigation has shown (as demonstrated in FIG. 3) that this use of a manifold does not normally provide for sufficient uniformity of effluent distribution or flow rates in actual drainage fields.

One attempted solution for a more uniform distribution is found in U.S. Pat. No. 6,270,661 issued Aug. 7, 2001 to Jowett. In Jowet an above-ground aeration station is shown assisting in the completion of aerobic treatment of the wastewater before that wastewater enters the ground. Jowet describes a complex system with moving parts below the ground surface in an effort to seek out uniformity.

Another is shown in US Pending Patent Application 2004/0253054 published Dec. 16, 2004 on the disclosure of Atchley. This provides a complex drainage field fed by a gravity driven flow from manifold element 28 to distribution pipe element 10 in FIG. 4.

A variable volume field is shown in U.S. Pat. No. 7,857,545 issued Dec. 28, 2010 to Burcham.

In U.S. Pat. No. 7,309,423, issued Dec. 18, 2007 to Branz, an additional air supply is fed to the drainage field to support biological activity in the partially filled distribution laterals by increasing both available oxygen supplies and processing times within those laterals.

### OBJECTS OF THE INVENTION

It is an object of the invention to provide an improved septic drainage system and method while maintaining the advantages of a conventional gravity-fed aerobic field of drainage lines useful over a wide variation in tile bed shapes and types.

It is a further object of the invention to provide an improved drainage system and method adapted to using existing commonly available and standardized components and while maintaining the size, shape and utility of a standard tile bed.

It is a further object of the invention to provide and maintain an improved septic system and method with a more active dosing wet cycle and to provide for improved usage of the whole of the drainage field both during dosing and in the period between dosing cycles.

It is a still further object of the invention to provide for enhanced utility and performance of conventional drainage fields at low cost across a wide spectrum of site specific fields, including previously installed systems, at low cost.

### SUMMARY OF THE INVENTION

The invention provides a septic system including a source of waste water effluent, a pressurized downstream flow from the source, a distribution header to receive said downstream flow, an unpressurized drainage field with a plurality of lateral drainage lines adapted to receive the downstream flow from the header, and a flow restriction between said header and at least one of said laterals creating a positive back pressure in said header. The flow restriction includes at least one flow orifice located between said header and said laterals. The orifice forms a nozzle which produces an accelerated stream of effluent into the lateral.

The invention also provides a septic system distribution nozzle including a distribution manifold and lateral downstream drainage lines which creates a positive back pressure between the lateral drainage lines and the manifold.

Further, the invention also provides a septic disposal method including providing source of waste water effluent, pressurizing the downstream flow from the source, receiving the downstream flow into a distribution header and from the header into an unpressurized drainage field with lateral drainage lines, and providing flow restriction means between the header and said laterals creating a positive back pressure in the header and an accelerated downstream flow of effluent into the laterals.

### BRIEF DESCRIPTION OF THE DRAWINGS

FIG. 1 is a perspective view of a typical prior art septic drainage field system with a transverse distribution manifold and in line perforated drainage lines.

FIG. 2 is a perspective view of an alternative typical prior art septic drainage field system with an in-line distribution manifold and transverse perforated drainage lines.

FIG. 3 is a perspective view of the transverse distribution manifold of a typical 3 inch prior art septic drainage field system, as in FIG. 1, in operation with a water effluent.

FIG. 4 is a vertical elevation of a typical T-connection to the 3 inch distribution manifold of FIG. 3.

FIG. 5 is a plan view of the T-connection of FIG. 4 including installation of the back-pressure distribution disk of the invention.

FIG. 6 is a perspective view of the installation of the distribution disk of FIG. 5.

FIG. 7 is an elevation of the distribution disk of FIGS. 4 and 5 installed to the T-connection of FIGS. 4 and 5.

FIG. 8 is a vertical perspective of the T-connection of FIG. 7 showing installation of the 3 inch distribution lateral.

FIG. 9 is a plan view of the T-connection of FIG. 8 with the distribution lateral installed.

FIG. 10 is a cross-sectional view of the operating distribution manifold of FIG. 3 showing flow at an early stage in the life of a drainage system

FIG. 11 is the cross-sectional view of the manifold of FIG. 10 with the distribution disk of FIGS. 5 through 9 installed.

FIG. 12 is a perspective view of the distribution system of the invention as installed to the manifold of FIG. 3.

FIG. 13 is a perspective view of the system of the invention as shown in FIG. 12 with the manifold rotated about its long axis and in operation with a water effluent.

### DESCRIPTION OF THE PREFERRED EMBODIMENTS

The present invention is directed to a wastewater treatment system and method addressing the need for improved utility and longevity of those typical septic systems which include a drainage field. The present invention is described by first summarizing prior art and current wastewater treatments systems.

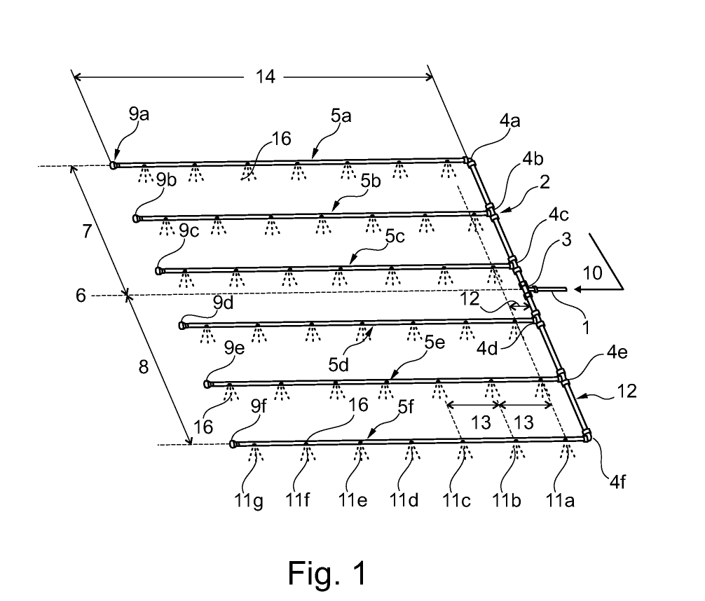

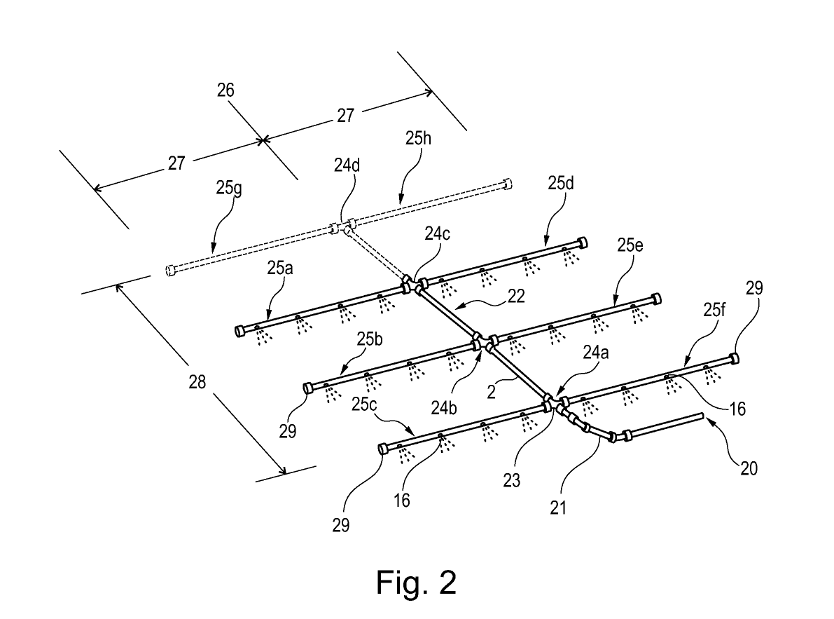

Referring first to FIG. 1, the drainage field or tile bed of a conventional residential wastewater, or septic, system is shown. Effluent from a primary septic tank or, preferably, a dosing system is provided as at 10 to the main field inlet 1. Often effluent 10 flows from the septic tank by gravity to the main inlet 1 where it enters an horizontal distribution manifold 2 which is transverse to the inlet 1, as in FIG. 1 or, alternatively, as effluent 20 in a central location as at 21 in FIG. 2. Preferably effluent 10 or 20 flows by gravity in a periodic pattern referred to as dosing. Dosing is typically provided between the inlet 1 in FIG. 1 and inlet 21 in FIG. 2 and the main septic tank (not shown) by coupling with a switched pump.

The transverse manifold 2 of FIG. 1 is connected to a plurality of horizontal distribution lateral lines or pipes 5. Individual lateral lines are identified as line 5a through 5f respectively in FIG. 1. T-connectors 4b, 4c and 4d and L-connectors 4a and 4f respectively join manifold 2 to the laterals 5. Laterals 5 may be slightly declined to encourage the flow of effluent along their length away from the manifold 2. Typically the manifold 2 and the laterals 5 are comprised of a rigid plastic tube with a design length 14 and nominal diameter of 3 or 4 inches. Each lateral 5 includes a series of spaced-apart perforations 11 throughout length 14 along its lower periphery, such as at 11 along later 5f in FIG. 1. In practise, the 1^{st} perforation 11a is spaced from manifold 2 by a distance 12 according to the design of the drainage field. Thereafter, perforations 11 are preferably spaced uniformly a distance 13 along the length 14 of line 5.

Most typically drainage fields, as in FIG. 1, are set out symmetrically around a center line 6 with equal widths 7 and 8 on either side of center line 6. Each line 5 is closed at its distal end by an end cap 9, identified as 9a through 9f in FIG. 1.

Referring to FIG. 2, the drainage field or tile bed of an alternative conventional residential wastewater, or septic, system is shown. Effluent 20 from a primary septic tank or, preferably, a dosing system is provided as at 21 to the main field inlet 23. In FIG. 2 the distribution manifold 2 is aligned longitudinally of the field along line 26 and is centrally located. Distribution laterals 25 extend horizontally outward a distance 27 or 28 as at 25a through 25h to form the drainage field. In this instance, each connection is provided by an X-connector 24 as at 24a through 24d. End caps 29 close each respective lateral.

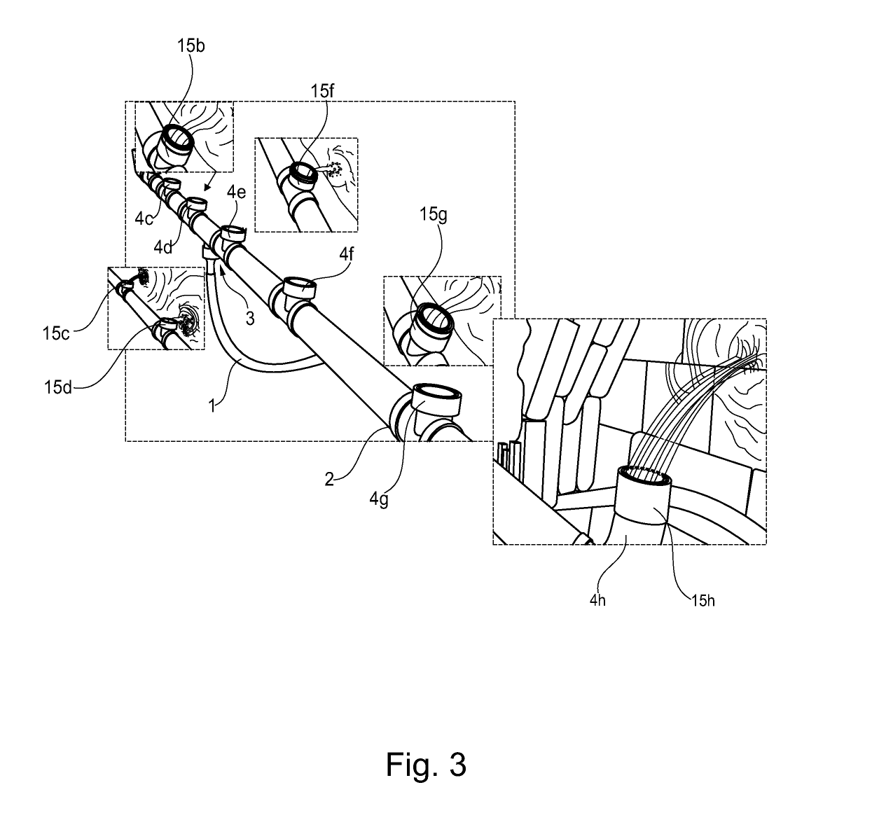

The distribution manifold 2 of FIG. 1 is shown in FIG. 3 in a typical operation with clean water for processing. In the case of FIG. 3 provision is made for 8 laterals by connectors 4a through 4h respectively. Manifold 2 is shown horizontally and transverse with a feed of clean water as at 1 in a central location 3. Unpressurized water flows by gravity along both sides of manifold 2 wherein it exits the manifold at each connector 4 encountered by the flow. In the steady state shown in FIG. 3 effluent flow is identified as 15a through 15h corresponding to connectors 4a through 4h respectively. The flow rate of water is shown to be smallest adjacent the central connectors 4d and 4e and increasing to the outermost connectors 4a and 4h. In practice, the individuals flows 15a through 15h vary considerably as they enter corresponding laterals where they continue flow by gravity along the length of the lateral 5. Each lateral 5 is emptied by flow 16 through corresponding perforations 11 into the base drainage material, not shown.

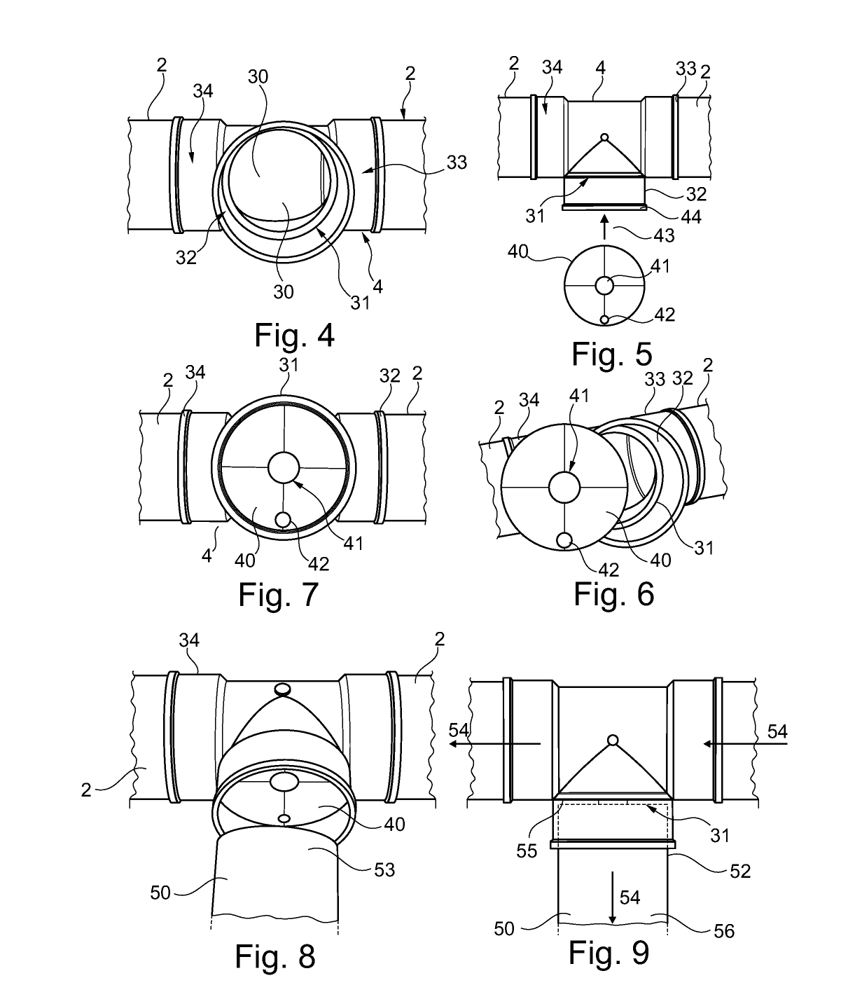

An elevation of a typical T-connector 4 (L or X-connectors are not separately shown as these are standard components) is shown in FIG. 4. Connector 4 is joined to separate sections of manifold 2 at flanges 33 and 34 and provides lateral connection collar 32 so as to provide an interior volume 30. An annular interior abutment 31 provides a stop. In prior art systems lateral collar 32 receives a lateral line 5 by a permanent connection with collar 32 in the fashion of flanges 33 and 34 as by glue.

In accordance with the preferred embodiment system and method of the invention a distribution control back pressure disk 40 is inserted into collar 32 as shown in FIG. 5 where it is secured as by glue and forms an outlet nozzle. Disk 40 includes a central flow orifice 41 and, preferably, a lowermost drain orifice 42. Preferably drain orifice 42 is considerably smaller, i.e. ¼ inch, than flow orifice 41.

A perspective view of the insertion of disk 40 shown in FIG. 5 is shown in FIG. 6.

As shown in FIG. 7, disk 40 is installed vertically abutting stop 31 with the drain orifice 42 at the lowermost point. Preferably, flow orifice 41 is sized at ½ inch diameter or smaller so that the sum of the total orifice area along the length of the manifold 2 is less than, and preferably considerably less than, the cross-sectional area of the manifold, so as to provide a positive back pressure into the manifold 2 as the system is charged with a dose of effluent.

Most preferably, drain orifice 42 is considerably smaller in diameter than central flow orifice 41 so as to complement the positive back pressure and allow for emptying of the manifold by gravity between dosing or during a period of non-supply.

As shown in FIG. 8 lateral 50 is then inserted into collar 32 in the conventional manner where it forms a permanent seal as at 53.

The completed assembly of the preferred embodiment of the system of the invention is shown in FIG. 9. Manifold flow 54 is constrained by the back-pressure to exit the manifold only through flow orifice 41 and drain orifice (if present) 42 to enter lateral 50 in a pressurized and accelerated flow.

Most preferably, flow orifice 41 is located well above the lower extremity of lateral 50 to increase the downstream turbulence resulting from the accelerated flow.

FIG. 10 shows an offset cross-section of the effluent flow in a typical prior art septic system taken in FIG. 3 at an early stage in the lifetime of the distribution system where the gravity flow does not necessarily reach the end cap 29. Inlet line 1 is typically 3 or 4 inch diameter solid pipe which receives effluent 10 flowing in an axial direction 60. Line 1 is either partially filled as at 65 or completely filled as it engages distribution manifold 2 at T-connector 4.

Effluent 10 is then diverted into the manifold 2, also typically 3 or 4 inch diameter, to flow transversely, in both directions 61a and 61b, and then onward toward each T-connector 4 and then into each corresponding lateral 5 along direction 61a. The flow in manifold 2 is by momentum and gravity and results in a line flow 67 in outward direction 62 at each lateral connection 4a through 4f. Flow 67 continues as at flow 68 in line direction 63 by gravity over and past perforation 11a and thence as at flow 70 in line direction 64 over and past perforation 11b and so on along the length of lateral 5 towards end cap 9. At each perforation 11 a portion of the effluent drains into the substrate as at 69 and 71.

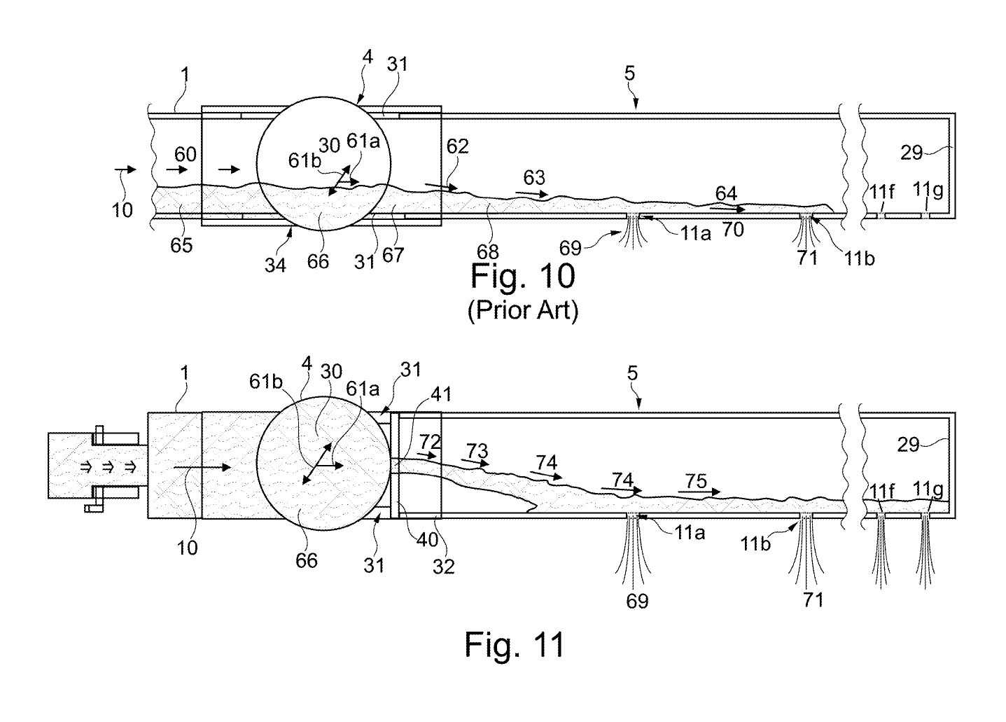

FIG. 11 shows an offset cross-section of the preferred embodiment system and method of the invention in the form of FIG. 10 of the prior art. Drain orifices 41 in disks 40 are sufficiently small enough to cause a build up of a positive back pressure and form a flow nozzle, that is above atmospheric, in distribution header 4 which causes the header 4 and input line 1 to fill with effluent as at 66. Pressurized effluent then flows through orifices 41 as at 72 in FIG. 11 as an accelerated and, preferably, elevated stream as from the nozzle. Depending on chosen parameters flow 72 will continue far into line 5 as at 73 before impacting line 5 in a turbulent flow as at 74 while maintaining much of its speed and momentum. Thereafter, flow 72 continues along line 5 as at 75 past and over perforations 11a and 11b where a portion drains into the substrate as at 69 and 71.

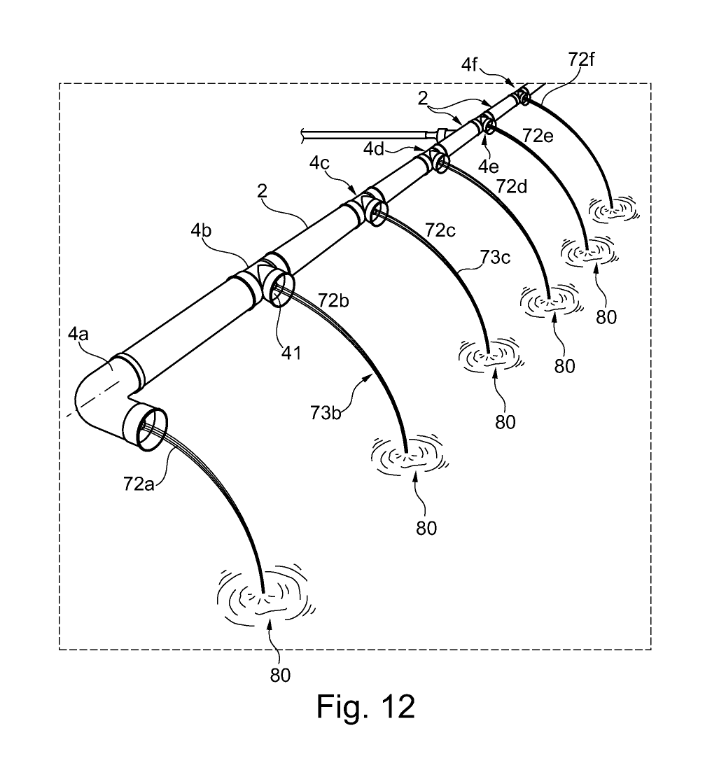

FIG. 12 shows a perspective view of the system and method of the invention of FIG. 11 in similar form to the prior art displayed in FIG. 3. Manifold header 4 is shown with a water feed at a central location 3 and 6 of 7 connections typically associated with further connection to a drainage field (not shown). Connectors include L-connector 4a at the proximate end and a range of T-connectors 4b through 4f evenly spaced along header 4. The L-connector at the distal end of FIG. 12 is not shown. Each T or L connector 4 includes a distribution nozzle 40 with a central flow orifice 41. Once the system of FIG. 12 is operating and manifold 2 is pressurized the steady state nozzle flow at each connector 4 is shown as at 72a through 72f respectively. At each connector flow 72 exits the nozzle at a relatively high velocity as at 73a through 73c. In each case flow 72 exits the nozzle 41 at a similar velocity and volume, as shown at 80 in FIG. 12.

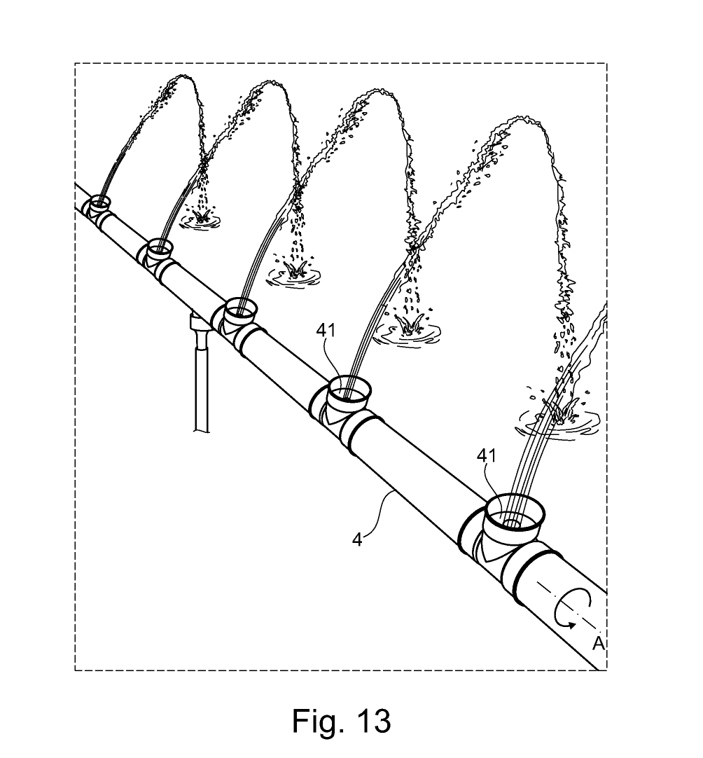

Downstream velocity and turbulence can be increased by an increase in back pressure in the header 4 as shown in FIG. 13 wherein the header 4 of FIG. 12 of has been rotated upwards about axis A to show a higher flow velocity.

Although the present invention has been described with preferred embodiments, it is to be understood that modifications and variations may be utilized without departing from the spirit and scope of the invention, as those skilled in the art will readily understand.

What I claim is:

1. A septic system including:
(a) a source of waste water effluent,
(b) means to provide a pressurized downstream flow from said source,
(c) a distribution header adapted to receive said downstream flow,
(d) an unpressurized drainage field comprised of a plurality of lateral drainage lines adapted to receive said downstream flow from said header,
(e) flow restriction means between said header and at least one of said laterals adapted to create a positive back pressure in said header.

2. A septic system as claimed in claim 1 wherein said flow restriction means includes a at least one flow orifice between said header and said at least one of said laterals.

3. A septic system as claimed in claim 2 wherein said flow orifice includes at least one nozzle.

4. A septic system as claimed in claim 3 where said nozzle is adapted to produce an accelerated stream of effluent into at least one said lateral.

5. A septic system as claimed in claim 4 wherein said stream is generally circular in cross-section.

6. A septic system as claimed in claim 4 wherein said accelerated stream penetrates into the body of a respective lateral a substantial portion of the length of said lateral.

7. A septic system as claimed in claim 2 wherein said flow orifice includes a pair of nozzles.

8. A septic system as claimed in claim 7 where said nozzles are adapted to produce an accelerated stream of effluent into at least one said lateral.

9. A septic system as claimed in claim 8 wherein at least one of said nozzles is adapted to produce said accelerated stream of generally circular cross-section.

10. A septic system as claimed in claim 9 wherein said accelerated stream penetrates into the body of a respective lateral a substantial portion of the length of said lateral.

11. A septic system as claimed in claim 10 wherein said substantial portion is greater than 5% of the length of said lateral.

12. A distribution nozzle adapted for a septic system including a distribution manifold and a plurality of lateral downstream drainage lines comprising means to create a positive back pressure between a plurality of said lateral drainage lines and said manifold.

13. A distribution nozzle as claimed in claim 12 wherein said distribution nozzle includes a line closing element, a main flow orifice and a drain orifice.

14. A distribution nozzle as claimed in claim 13 wherein said main flow orifice is substantially larger than said drain orifice.

15. A distribution nozzle as claimed in claim 14 wherein said main flow orifice is centrally located with respect to said line closing element.

16. A distribution nozzle as claimed in claim 15 wherein said drain orifice is located below said main flow orifice.

17. A septic disposal method including:
(a) providing source of waste water effluent,
(b) pressurizing the downstream flow from said source,
(c) receiving said downstream flow into a distribution header and from said header into an unpressurized drainage field comprised of a plurality of lateral drainage lines,
(d) providing flow restriction means between said header and at least one of said laterals adapted to create a positive back pressure in said header and an accelerated downstream flow of said effluent into said lateral.
